(19) United States
(12) Patent Application Publication
(10) Pub. No.: US 2021/0298398 A1
(43) Pub. Date: Sep. 30, 2021

(54) COMPOSITE PROTECTIVE MATERIAL FOR EPIDEMIC PREVENTION OF COVID-19 AND METHOD FOR PREPARING SAME

(71) Applicant: Dalian Shuangdi Taohua Health Products Co., Ltd., Dalian City (CN)

(72) Inventor: Hong Liu, Dalian City (CN)

(21) Appl. No.: 17/184,007

(22) Filed: Feb. 24, 2021

(30) Foreign Application Priority Data
Mar. 24, 2020 (CN) 202010209602.3

(51) Int. Cl. A41D 31/30; C08K 9/04; C08K 5/29; C08K 3/04; A41D 31/02; A41D 31/14; B32B 5/02; B32B 5/26; A41D 13/11; D04H 3/011; D06M 11/74

(52) U.S. Cl. CPC A41D 31/305; D06M 2101/32; C08K 5/29; C08K 3/042; A41D 31/02; A41D 31/14; B32B 5/022; B32B 5/26; A41D 13/1192; D04H 3/011; D06M 11/74; A41D 2500/30; B32B 2262/0276; B32B 2307/714; B32B 2307/724; B32B 2437/00; B32B 2250/20; B32B 2262/062; B32B 2262/0261; C08K 9/04

(57) ABSTRACT

The disclosure provides a composite protective material for epidemic prevention of corona virus disease 2019 (COVID-19) and a preparation method thereof. The composite protective material for epidemic prevention of COVID-19 comprises a support layer, a nanofiber antibacterial layer and a skin friendly layer which are successively arranged from outside to inside, wherein the nanofiber antibacterial layer comprises at least one layer of hydroxyl terminated hyperbranched polyester nanofiber non-woven fabric loaded with graphene modified by diisocyanate and at least one layer of carboxyl terminated hyperbranched polyester nanofiber non-woven fabric loaded with graphene modified by polyethylene polyamine, wherein the hydroxyl terminated hyperbranched polyester nanofiber non-woven fabric and the carboxyl terminated hyperbranched polyester nanofiber non-woven fabric are condensed and crosslinked to form a penetrating network; the graphene modified by diisocyanate and the terminal hydroxyl of the hydroxyl terminated hyperbranched polyester nanofiber or amino of polyethylene polyamine form chemical bonding, the amino of polyethylene polyamine and the terminal carboxyl of the carboxyl terminated hyperbranched polyester nanofiber or isocyanate of diisocyanate form chemical bonding, thereby endowing dacron fabrics with excellent antibacterial property, chemical property and air permeability.

### TECHNICAL FIELD

The disclosure belongs to the technical field of textile materials, and relates to a composite protective material for epidemic prevention of corona virus disease 2019 (COVID-19) and a method for preparing the same.

### BACKGROUND

With the gradual improvement of people's living standards, more and more attention has been paid to personal hygiene and health problems. As a necessity of human life, more and more attention has been paid to the safety and health functions of fiber textiles. In this social trend, researches on various antibacterial protective fabrics have developed rapidly in recent years. And since twenty-first century, with the successive outbreak of influenza viruses such as influenza a H1N1, avian influenza, horse influenza, SARS pathogens and corona virus disease 2019, these viruses enter the lungs through the upper and lower respiratory tracts and bronchus, and enter the blood of a human body through the alveoli, so as to bring a major threat to human health. Therefore, more stringent requirements are put forward for protective clothing, masks and other protective measures to provide more comprehensive protection for wearing.

Due to good mechanical properties, acid and alkali resistance, organic solvent resistance and low price, dacron (polyester) non-woven fabrics are often used as disposable or limited use protective clothing, surgical clothing, masks and other medical and health products, but generally need to add antibacterial agents to achieve the antibacterial function. In recent years, researchers have found that nanostructured graphene and its derivative graphene oxide material have a certain cytotoxicity and antibacterial property, so how to improve the loading capacity and durability of graphene on fiber fabrics is a key to improve the antibacterial properties of fiber fabrics.

The Chinese invention patent No. 201710495022.3 discloses a multifunctional graphene/polyester composite fabric and a preparation method thereof. The graphene/PET nano composite material is prepared through in-situ polycondensation by adding spherical graphene and a catalyst into a PET precursor, and then post-finishing such as high-speed melt spinning, cooling, oiling and drafting. In this method, although the surface of graphene is covalently bonded with a PET molecule, the durability of graphene is improved, but there are few active groups on the PET molecular chain, and the loading capacity of graphene is low.

As graphene is an inorganic material, how to establish physical or chemical interaction between graphene and organic macromolecules of polyester fabric is the technical difficulty to realize its durability. However, the mechanical property, air permeability and comfort level and other properties of the dacron fabric are usually decreased while improving the durability and loading capacity of graphene, and the wearability of the fiber fabric is affected.

### SUMMARY

Aiming at the defects existing in the above prior art, the objective of the disclosure is to provide a composite protective material for epidemic prevention of COVID-19 and a method for preparing the same. Active group contents of polyester are increased by utilizing hydroxyl or carboxyl terminated hyperbranched polyester, so as to increase the loading capacity of graphene, the mechanical strength, barrier property and graphene durability of the dacron fabric through a penetrating network formed by condensed crosslinking of the hydroxyl terminated hyperbranched polyester nanofiber non-woven fabric and the carboxyl terminated hyperbranched polyester nanofiber non-woven fabric and a penetrating network formed by crosslinking of graphene in two layers of non-woven fabrics, so as to improve the antibacterial property and wearability of the protective material.

In order to achieve the above objective, the technical solution used by the disclosure is as follows:

A composite protective material for epidemic prevention of corona virus disease 2019 (COVID-19), comprising: a support layer, a nanofiber antibacterial layer and a skin friendly layer which are successively arranged from outside to inside, wherein the nanofiber antibacterial layer comprises at least one layer of hydroxyl terminated hyperbranched polyester nanofiber non-woven fabric loaded with graphene and at least one layer of carboxyl terminated hyperbranched polyester nanofiber non-woven fabric loaded with graphene, and the hydroxyl terminated hyperbranched polyester nanofiber non-woven fabric and the carboxyl terminated hyperbranched polyester nanofiber non-woven fabric are adjacently arranged and condensed and crosslinked through terminal hydroxyl and terminal carboxyl to form a penetrating network.

Further, graphene loaded on the hydroxyl terminated hyperbranched polyester nanofiber non-woven fabric is graphene modified by diisocyanate; graphene loaded on the carboxyl terminated hyperbranched polyester nanofiber is graphene modified by polyethylene polyamine; and isocyanate of diisocyanate and the terminal hydroxyl of the hydroxyl terminated hyperbranched polyester nanofiber or amino of polyethylene polyamine form chemical bonding, the amino of polyethylene polyamine and the terminal carboxyl of the carboxyl terminated hyperbranched polyester nanofiber or isocyanate of diisocyanate form chemical bonding.

Further, the hydroxyl terminated hyperbranched polyester nanofiber non-woven fabric contains hydroxyl terminated hyperbranched polyester with a high branching degree and having a softening point of 80˜120° C. and hydroxyl terminated hyperbranched polyester with a low branching degree and having a softening point of 180˜220° C.; the carboxyl terminated hyperbranched polyester nanofiber non-woven fabric contains carboxyl terminated hyperbranched polyester masterbatch with a high branching degree and having a softening point of 80˜120° C. and carboxyl terminated hyperbranched polyester with a low branching degree and having a softening point of 180˜220° C.

Further, the diisocyanate is any one of hexamethylene diisocyanate, toluene diisocyanate or diphenylmethane diisocyanate; the polyethylene polyamine is any one of ethylene diamine, diethylenetriamine, triethylenetetramine and tetraethylene pentamine.

Further, the support layer is spunlaced non-woven fabric, spunbond non-woven fabric or meltblown non-woven fabric, and the material of the skin friendly layer is polyimide fiber, dacron, nylon, cotton or polyester cotton.

A method for preparing the composite protective material for epidemic prevention of COVID-19, comprising the following steps:

S1, preparation of hydroxyl terminated hyperbranched polyester nanofiber non-woven fabric

carrying out melt extrusion, drafting and paving into a mesh on hydroxyl terminated hyperbranched polyester masterbatch and cellulose acetate butyrate which are in a mass ratio of 1:(4˜9) are subjected to melt extrusion via a double-screw extruder, drafted and paved into a mesh to obtain a hydroxyl terminated hyperbranched polyester/cellulose acetate butyrate blend fiber non-woven fabric; the hydroxyl terminated hyperbranched polyester masterbatch contains hydroxyl terminated hyperbranched polyester masterbatch with a high branching degree and having a softening point of 80˜120° C. and hydroxyl terminated hyperbranched polyester masterbatch with a low branching degree and having a softening point of 180˜220° C.;

the graphene modified by diiscocyanate is dispersed into a mixed solvent of ethanol and acetone having a volume ratio of 10%:90%˜40%:60% to obtain a graphene dispersion solution having a concentration of 0.2˜1 mg/mL; and

the hydroxyl terminated hyperbranched polyester/cellulose acetate butyrate blend fiber non-woven fabric is impregnated into the graphene dispersion solution so that the graphene is adsorbed on the hydroxyl terminated hyperbranched polyester fiber while dissolving and removing the cellulose acetate butyrate, so as to obtain hydroxyl terminated hyperbranched polyester nanofiber non-woven fabric loaded with graphene; and

S2, preparation of carboxyl terminated hyperbranched polyester nanofiber non-woven fabric

carboxyl terminated hyperbranched polyester masterbatch and cellulose acetate butyrate which are in a mass ratio of 1:(4˜9) are subjected to melt extrusion via a double-screw extruder, drafted and paved into a mesh to obtain carboxyl terminated hyperbranched polyester/cellulose acetate butyrate blend fiber non-woven fabric; the carboxyl terminated hyperbranched polyester masterbatch contains carboxyl terminated hyperbranched polyester masterbatch with a high branching degree and having a softening point of 80˜120° C. and carboxyl terminated hyperbranched polyester masterbatch with a low branching degree and having a softening point of 180˜220° C.;

the graphene modified by polyethylene polyamine is dispersed into a mixed solvent of ethanol and acetone with a volume ratio of 10%:90%˜40%:60% to obtain a graphene dispersion solution with a concentration of 0.2˜1 mg/mL;

the carboxyl terminated hyperbranched polyester/cellulose acetate butyrate blend fiber non-woven fabric is impregnated into the graphene dispersion solution, wherein graphene is adsorbed on the carboxyl terminated hyperbranched polyester fiber while dissolving and removing cellulose acetate butyrate to obtain the carboxyl terminated hyperbranched polyester nanofiber non-woven fabric loaded with graphene; and

S3, preparation of composite protective material

the support layer, the hydroxyl terminated hyperbranched polyester fiber nanofiber non-woven fabric loaded with graphene, the carboxyl terminated hyperbranched polyester fiber nanofiber non-woven fabric loaded with graphene and a skin friendly layer are successively arranged, and then hot rolling is carried out at 120˜150° C. and 1˜5 MPa to obtain a composite protective material for epidemic prevention of COVID-19.

Further, in the step of S1, a molar ratio of hydroxyl terminated hyperbranched polyester masterbatch with a high branching degree and having a softening point of 80˜120° C. to hydroxyl terminated hyperbranched polyester masterbatch with a low branching degree and having a softening point of 180˜220° C. is 5%:95%˜20%:80%; in the step of S2, a molar ratio of carboxyl terminated hyperbranched polyester masterbatch with a high branching degree and having a softening point of 80˜120° C. to carboxyl terminated hyperbranched polyester masterbatch with a low branching degree and having a softening point of 180˜220° C. is 5%:95%˜20%:80%.

Further, the carboxyl terminated hyperbranched polyester masterbatch with a high branching degree and having a softening point of 80˜120° C. is obtained by terminal group modification of the hydroxyl terminated hyperbranched polyester masterbatch with a high branching degree and having a softening point of 80˜120° C. with succinic anhydride; the carboxyl terminated hyperbranched polyester masterbatch with a low branching degree and having a softening point of 180˜220° C. is obtained by terminal group modification of the hydroxyl terminated hyperbranched polyester masterbatch with a low branching degree and having a softening point of 180˜220° C. with succinic anhydride.

Further, in the step of S1, the hydroxyl terminated hyperbranched polyester masterbatch is prepared by the following steps:

S101, hydroxyl terminated hyperbranched polyester oligomer: trimethylolpropane and dimethylolpropionic acid which are in a molar ratio of 1:(3˜9) are added into a reaction vessel, heated to 110˜120° C. and react for 2˜4 h under the protection of nitrogen to obtain the hydroxyl terminated hyperbranched polyester oligomer;

S102, carboxyl terminated polyester oligomer: dicarboxylic acid and diol which are in a molar ratio of (1.05˜1.3):1 are added into a reaction vessel, heated to 250˜260° C. under the protection of nitrogen, and react for 2˜4 h to obtain the carboxyl terminated polyester oligomer;

S103, carboxyl terminated polyester oligomer: dicarboxylic acid and diol which are in a molar ratio of (1.5˜1.8):1 are added into a reaction vessel, heated to 250˜260° C. under the protection of nitrogen, and react for 2˜4 h to obtain the carboxyl terminated polyester oligomer;

S104, hydroxyl terminated hyperbranched polyester masterbatch with a low branching degree and having a softening point of 180˜220° C.: the hydroxyl terminated hyperbranched polyester oligomer obtained in step S101 is added into the carboxyl terminated polyester oligomer obtained in step S102, subjected to polycondensation for 1˜3 h at 275˜285° C. and 200˜300 kPa, vacuumized for 2˜4 h, cooled and cut to obtain the hydroxyl terminated hyperbranched polyester masterbatch with a low branching degree and having a softening point of 180˜220° C.; and

S105, the hydroxyl terminated hyperbranched polyester masterbatch with a high branching degree and having a softening point of 80˜120: the hydroxyl terminated hyperbranched polyester oligomer obtained in step S101 is added into the carboxyl terminated hyperbranched polyester oligomer obtained in step S103 at 275˜285° C. and 200˜300 kPa, subjected to polycondensation for 1˜3 h, then vacuumized for 2˜4 h, cooled and cut to obtain the hydroxyl terminated hyperbranched polyester masterbatch with a high branching degree and having a softening point of 80˜120° C.

Further, in the step of S104, a mass ratio of the hydroxyl terminated hyperbranched polyester oligomer to the carboxyl terminated hyperbranched polyester oligomer is 1:(4˜6); in the step of S105, a mass ratio of the hydroxyl terminated hyperbranched polyester oligomer to the carboxyl terminated hyperbranched polyester oligomer is 1:(0.5˜1.5).

### Beneficial Effects

Compared with the prior art, the composite protective material for epidemic prevention of corona virus disease 2019 (COVID-19) and the method for preparing the same provided by the disclosure have the following beneficial effects:

The composite protective material for epidemic prevention of COVID-19 provided by the disclosure comprises the support layer, the nanofiber antibacterial layer and the skin friendly layer successively arranged from outside to inside, and the nanofiber antibacterial layer comprises at least one layer of hydroxyl terminated hyperbranched polyester nanofiber non-woven fabric loaded with graphene modified by diisocyanate and at least one layer of carboxyl terminated hyperbranched polyester nanofiber non-woven fabric loaded with graphene modified by polyethylene polyamine. In this way, the hydroxyl terminated hyperbranched polyester nanofiber non-woven fabric and the carboxyl terminated hyperbranched polyester nanofiber non-woven fabric form a penetrating network through condensation crosslinking of terminal hydroxyl and terminal carboxyl; the graphene modified by diisocyanate and the terminal hydroxyl of the hydroxyl terminated hyperbranched polyester nanofiber or the amino of polyethylenepolyamine form chemical bonding, the amino of polyethylene polyamine and the terminal carboxyl of the carboxyl terminated hyperbranched polyester nanofiber or isocyanate of diisocyanate form chemical bonding, thereby endowing polyester fabric with excellent antibacterial property, mechanical property and air permeability.

(2) The nano antibacterial layer of the composite protective material for epidemic prevention of COVID-19 provided by the disclosure comprises at least one layer of hydroxyl terminated hyperbranched polyester nanofiber non-woven fabric loaded with graphene and at least one layer of carboxyl terminated hyperbranched polyester nanofiber non-woven fabric loaded with graphene, wherein the hydroxyl terminated hyperbranched polyester nanofiber non-woven fabric contains hydroxyl terminated hyperbranched polyester with a high branching degree and having a softening point of 80˜120° C. and hydroxyl terminated hyperbranched polyester with a low branching degree and having a softening point of 180˜220° C., which are in a mass ratio of 5%:95%˜20%:80%; the carboxyl terminated hyperbranched polyester nanofiber non-woven fabric contains carboxyl terminated hyperbranched polyester with a high branching degree and having a softening point of 80˜120° C. and carboxyl terminated hyperbranched polyester with a low branching degree and having a softening point of 180˜220° C., which are in a mass ratio of 5%:95%—20%:80%. By utilizing fused cohesive action of the hydroxyl or carboxyl terminated hyperbranched polyester, the cohesive strength between fibers is improved, and the active group content is increased, thereby increasing the loading capacity of graphene.

(3) The method for preparing the composite protective material for epidemic prevention of COVID-19 provided by the disclosure comprises: polyester masterbatch is blended and yarned with cellulose acetate butyrate, then a solvent for dispersion solution graphene is used to dissolve and remove cellulose acetate butyrate to obtain polyester nanofiber non-woven fabric, and meanwhile graphene is adsorbed on the surface of the polyester nanofiber. The formation of the nanofiber non-woven fabric not only improves the air permeability of the non-woven fabric but also increases the specific surface area, and then increases the loading capacity of graphene; finally, the support layer, the polyester nanofiber non-woven fabric and the skin friendly layer are laminated, then subjected to hot rolling so that multiple chemical bonding occurs between fibers, between layers, between graphene and fibers, and between graphene and graphene, thereby obtaining the protective material having high antibacterial property, high breaking strength and high air permeability. The whole preparation method is simple and feasible, and suitable for large-scale production.

### BRIEF DESCRIPTION OF THE DRAWINGS

FIG. 1 is a structural diagram of a composite protective material for epidemic prevention of COVID-19 provided by the disclosure.

### DESCRIPTION OF THE EMBODIMENTS

Next, the technical solutions of various embodiments of the disclosure will be clearly and completely described, obviously, the described embodiments are only a part of embodiments of the disclosure but not all the examples; based on the embodiments of the disclosure, other embodiments obtained by persons of ordinary skill in the art without creative efforts are all included within the protective scope of the disclosure.

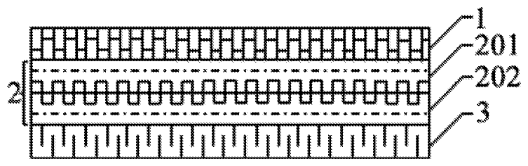

Referring to FIG. 1, the composite protective material for epidemic prevention of COVID-19 provided by the disclosure comprises a support layer 1, a nanofiber antibacterial layer 2 and a skin friendly layer 3 which are successively arranged from outside to inside, wherein the nanofiber antibacterial layer comprises at least one layer of hydroxyl terminated hyperbranched polyester nanofiber non-woven fabric 201 loaded with graphene and at least one layer of carboxyl terminated hyperbranched polyester nanofiber non-woven fabric 202 loaded with graphene, and the hydroxyl terminated hyperbranched polyester nanofiber non-woven fabric 201 and the carboxyl terminated hyperbranched polyester nanofiber non-woven fabric 202 are adjacently arranged, and condensed and crosslinked through terminal hydroxyl and terminal carboxyl to form a penetrating network.

Further, the graphene loaded on the hydroxyl terminated hyperbranched polyester nanofiber non-woven fabric is graphene modified by diisocyanate; the graphene loaded on the carboxyl terminated hyperbranched polyester nanofiber non-woven fabric is graphene modified by polyethylene polyamine; and isocyanate of diisocyanate and the terminal hydroxyl of hydroxyl terminated hyperbranched polyester nanofiber or amino of polyethylene polyamine form chemical bonding, the amino of polyethylene polyamine and the terminal carboxyl of the carboxyl terminated hyperbranched polyester nanofiber or isocyanate of diisocyanate form chemical bonding.

Further, the hydroxyl terminated hyperbranched polyester nanofiber non-woven fabric contains hydroxyl terminated hyperbranched polyester with a high branching degree and having a softening point of 80˜120° C. and hydroxyl terminated hyperbranched polyester with a low branching degree and having a softening point of 180˜220° C.; the carboxyl terminated hyperbranched polyester nanofiber non-woven fabric contains carboxyl terminated hyperbranched polyester masterbatch with a high branching degree and having a softening point of 80˜120° C. and carboxyl terminated hyperbranched polyester with a low branching degree and having a softening point of 180˜220° C.

In this way, the composite protective material for epidemic prevention of COVID-19 is obtained by successively laminating the support layer 1, the hydroxyl terminated hyperbranched polyester nanofiber non-woven fabric 201 loaded with graphene and the carboxyl terminated hyperbranched polyester nanofiber non-woven fabric 202 loaded with graphene and then hot rolling at 120˜150° C. and 1˜5 MPa. In the process of hot rolling, the following reactions occur:

(1) In the hydroxyl-terminated hyperbranched polyester nanofiber non-woven fabric 201, the hydroxyl-terminated hyperbranched polyester with a high branching degree and having a softening point of 80˜120° C. is molten and cohered, so as to increase cohesive strength between fibers in the hydroxyl-terminated hyperbranched polyester nanofiber non-woven fabric 201.

(2) In the carboxyl-terminated hyperbranched polyester nanofiber non-woven fabric 202, the hydroxyl-terminated hyperbranched polyester with a low branching degree and having a softening point of 80˜120° C. is molten and cohered, so as to increase the cohesive strength between fibers in the carboxyl-terminated hyperbranched polyester nanofiber non-woven fabric 202;

(3) The hydroxyl groups on the surface of the hydroxyl-terminated hyperbranched polyester nanofiber non-woven fabric 201 and the carboxyl groups on the surface of the carboxyl-terminated hyperbranched polyester nanofiber non-woven fabric 202 are condensed and crosslinked to form a penetrating network, so as to increase the cohesive strength between the hydroxyl-terminated hyperbranched polyester nanofiber non-woven fabric 201 and the carboxyl-terminated hyperbranched polyester nanofiber non-woven fabric 202;

(4) The graphene modified by diisocyanate and the hydroxyl group on the surface of the hydroxyl-terminated hyperbranched polyester nanofiber non-woven fabric undergo addition crosslinking to form chemical bonding, so that the graphene is stably fixed on the non-woven fabric;

(5) The graphene modified by polyethylene polyamine and the carboxyl group on the surface of the carboxyl terminated hyperbranched polyester nanofiber non-woven fabric are condensed and crosslinked to form chemical bonding, so that the graphene is stably fixed on the non-woven fabric;

(6) the graphene modified with diisocyanate and the graphene modified by polyethylene polyamine undergo addition and crosslinking to form chemical bonding to form a penetrating network, so as to improve the loading fastness of the graphene and also increase the cohesive strength between the hydroxyl terminated hyperbranched polyester nanofiber non-woven fabric 201 and the carboxyl terminated hyperbranched polyester nanofiber non-woven fabric 202

Through the above series of reactions, the loading capacity and loading fastness of the graphene on the nanofiber antibacterial layer 2 are both significantly improved, and the mechanical strength and air permeability of the nanofiber antibacterial layer are excellent, thereby endowing the composite protective material for epidemic prevention of COVID-19 with good antibacterial property and wearability.

Further, the diisocyanate is any one of hexamethylene diisocyanate, toluene diisocyanate or diphenylmethane diisocyanate; the polyethylene polyamine is any one of ethylene diamine, diethylenetriamine, triethylenetetramine and tetraethylene pentamine.

Further, the support layer is spunlaced non-woven fabric, spunbond non-woven fabric or meltblown non-woven fabric, and the material of the skin friendly layer is polyimide fiber, dacron, nylon, cotton or polyester cotton.

The disclosure provides a test method of antibacterial property, durability and wearability of the composite protective material for epidemic prevention of COVID-19, which is as follows:

(1) Antibacterial Property Test

The protective materials prepared by the following examples and comparative examples are tested by reference to part three from standard GB/T20944.3-2008 “EVALUATION OF ANTIBACTERIAL PROPERTIES OF TEXTILES: OSCILLATING METHOD”. The selected bacteria are gram positive Staphylococcus aureus and gram negative Klebsiella pneumoniae.

(2) Washability Test

The protective materials prepared by the following examples and comparative examples are washed 20 times, and then their antibacterial properties are tested according to a test method (1).

(3) Wearability Test

The tensile failure strength of the protective material is tested on a HD026 N electronic fabric strength tester. The textile fabric to be tested is cut into 10 cm×10 cm with a spacing of 80 mm. 15 pieces of each fabric are tested.

According to GB/T 5453-1997 “TEST METHOD FOR AIR PERMEABILITY OF FABRICS”, a YG461E computerized air permeability tester is used to test air permeability of fabrics.

The disclosure will be further described through specific examples and comparative examples.

### Example 1

A composite protective material for epidemic prevention of COVID-19 comprised a support layer, a nanofiber antibacterial layer and a skin friendly layer which were successively arranged from outside to inside, wherein the nanofiber antibacterial layer comprised a layer of hydroxyl terminated hyperbranched polyester nanofiber non-woven fabric loaded with graphene modified by hexamethylene diisocyanate and a layer of carboxyl terminated hyperbranched polyester nanofiber non-woven fabric loaded with graphene modified by diethylenetriamine. The composite protective material for epidemic prevention of COVID-19 was prepared by the following steps:

S1, preparation of hydroxyl terminated hyperbranched polyester nanofiber non-woven fabric

Hydroxyl terminated hyperbranched polyester mastertaches and cellulose acetate butyrate which were in a mass ratio of 1:8 were subjected to melt extrusion via a twin-screw extruder, drafted and paved into a meshed, so as to obtain a hydroxyl terminated hyperbranched polyester/cellulose acetate butyrate blend fiber non-woven fabric; the hydroxyl terminated hyperbranched polyester masterbatch contains hydroxyl terminated hyperbranched polyester masterbatch with a high branching degree and having a softening point of 100° C. and hydroxyl terminated hyperbranched polyester masterbatch with a low branching degree and having a softening point of 200° C., which were in a mass ratio of 10%:90%;

the graphene modified by hexamethylene diiscocyanate was dispersed into a mixed solvent of ethanol and acetone having a volume ratio of 20%˜80% to obtain a graphene dispersion solution having a concentration of 0.5 mg/mL; and

the hydroxyl terminated hyperbranched polyester/cellulose acetate butyrate blend fiber non-woven fabric was impregnated into the graphene dispersion solution so that the graphene is adsorbed on the hydroxyl terminated hyperbranched polyester fiber while dissolving and removing the cellulose acetate butyrate, so as to obtain hydroxyl terminated hyperbranched polyester nanofiber non-woven fabric loaded with graphene; and

S2, preparation of carboxyl terminated hyperbranched polyester nanofiber non-woven fabric

Carboxyl terminated hyperbranched polyester mastertaches and cellulose acetate butyrate which were in a mass ratio of 1:8 were subjected to melt extrusion via a twin-screw extruder, drafted and paved into a meshed, so as to obtain a carboxyl terminated hyperbranched polyester/cellulose acetate butyrate blend fiber non-woven fabric; the carboxyl terminated hyperbranched polyester masterbatch contains hydroxyl terminated hyperbranched polyester masterbatch with a high branching degree and having a softening point of 100° C. and carboxyl terminated hyperbranched polyester masterbatch with a low branching degree and having a softening point of 200° C., which were in a mass ratio of 10%:90%;

the graphene modified by diethenetriamine was dispersed into a mixed solvent of ethanol and acetone which were in a volume ratio of 20%-80% to obtain a graphene dispersion solution with a concentration of 0.5 mg/mL;

the carboxyl terminated hyperbranched polyester/cellulose acetate butyrate blend fiber non-woven fabric was impregnated into the graphene dispersion solution, graphene is adsorbed on the carboxyl terminated hyperbranched polyester fiber while dissolving and removing cellulose acetate butyrate to obtain the carboxyl terminated hyperbranched polyester nanofiber non-woven fabric loaded with graphene; and

S3, preparation of composite protective material

The support layer, the hydroxyl terminated hyperbranched polyester nanofiber non-woven fabric loaded with graphene, the carboxyl terminated hyperbranched polyester nanofiber non-woven fabric loaded with graphene and the skin friendly layer were successively laminated, and then subjected to hot rolling at 130° C. and 2 MPa to obtain a composite protective material for epidemic prevention of COVID-19.

In the step of S1, the hydroxyl terminated hyperbranched polyester masterbatch was prepared by the following steps:

S101, hydroxyl terminated hyperbranched polyester oligomer: trimethylolpropane and dimethylolpropionic acid which were in a molar ratio of 1:6 were added into a reaction vessel, and then heated to 110˜120° C. for 2˜4 h under the protection of nitrogen to obtain the hydroxyl terminated hyperbranched polyester oligomer;

S102, carboxyl terminated polyester oligomer: dicarboxylic acid and diol which were in a molar ratio of 1.2:1 were added into a reaction vessel, heated to 250˜260° C. under the protection of nitrogen, and reacted for 2˜4 h to obtain the carboxyl terminated polyester oligomer;

S103, carboxyl terminated polyester oligomer: dicarboxylic acid and diol which were in a molar ratio of 1.6:1 were added into a reaction vessel, heated to 250˜260° C. under the protection of nitrogen, and reacted for 2˜4 h to obtain the carboxyl terminated polyester oligomer;

S104, hydroxyl terminated hyperbranched polyester masterbatch with a low ee and branching degrhaving a softening point of 200° C.: in a mass ratio of 1:5, the hydroxyl terminated hyperbranched polyester oligomer obtained in step S101 was added into the carboxyl terminated polyester oligomer obtained in step S102, the above substances were subjected to polycondensation for 1˜3 h at 275˜285° C. and 200˜300 kPa, vacuumized for 2˜4 h, and cooled and cut to obtain the hydroxyl terminated hyperbranched polyester masterbatch with a low branching degree and having a softening point of 200° C.; and

S105, hydroxyl terminated hyperbranched polyester masterbatch with a high branching degree and having a softening point of 100° C.: in a mass ratio of 1:1, the hydroxyl terminated hyperbranched polyester oligomer obtained in step S101 was added into the carboxyl terminated hyperbranched polyester oligomer obtained in step S103, subjected to polycondensation for 1˜3 h at 275˜285° C. and 200˜300 kPa, then vacuumized for 2˜4 h, cooled and cut to obtain the hydroxyl terminated hyperbranched polyester masterbatch with a high branching degree and having a softening point of 100° C.

In the step of S2, the carboxyl terminated hyperbranched polyester masterbatch with a high branching degree and having a softening point of 100° C. was obtained by terminal group medication of the hydroxyl terminated hyperbranched polyester masterbatch with a high branching degree and having a softening point of 100° C. with succinic anhydride; the carboxyl terminated hyperbranched polyester masterbatch with a low branching degree and having a softening point of 200° C. was obtained by terminal group modification of the hydroxyl terminated hyperbranched polyester masterbatch with a low branching degree and having a softening point of 200° C. with succinic anhydride.

### Comparative Example 1

A composite protective material for epidemic prevention of COVID-19 provided in comparative example 1 comprised a support layer, a nanofiber antibacterial layer and a skin friendly layer which were successively arranged from outside to inside, wherein the nanofiber antibacterial layer comprised a layer of hydroxyl terminated polyethylene terephthalate nanofiber non-woven fabric loaded with graphene modified by hexamethylene diisocyanate and a layer of carboxyl terminated polyethylene terephthalate nanofiber non-woven fabric loaded with graphene modified by diethylenetriamine. The composite protective material for epidemic prevention of COVID-19 was prepared by the following steps:

S1, preparation of hydroxyl terminated polyethylene terephthalate nanofiber non-woven fabric

Hydroxyl terminated polyethylene terephthalate mastertaches and cellulose acetate butyrate which were in a mass ratio of 1:8 were subjected to melt extrusion via a twin-screw extruder, drafted and paved into a meshed, so as to obtain a hydroxyl terminated polyethylene terephthalate/cellulose acetate butyrate blend fiber non-woven fabric;

the graphene modified by hexamethylene diiscocyanate was dispersed into a mixed solvent of ethanol and acetone which were in a volume ratio of 20%-80% to obtain a graphene dispersion solution having a concentration of 0.5 mg/mL; and

the hydroxyl terminated polyethylene terephthalate/cellulose acetate butyrate blend fiber non-woven fabric was impregnated into the graphene dispersion solution so that the graphene is adsorbed on the hydroxyl terminated polyethylene terephthalate fiber while dissolving and removing the cellulose acetate butyrate, so as to obtain hydroxyl terminated polyethylene terephthalate nanofiber non-woven fabric loaded with graphene; and

S2, preparation of carboxyl terminated polyethylene terephthalate nanofiber non-woven fabric

Carboxyl terminated polyethylene terephthalate mastertaches and cellulose acetate butyrate which were in a mass ratio of 1:8 were subjected to melt extrusion via a twin-screw extruder, drafted and paved into a meshed, so as to obtain a carboxyl terminated polyethylene terephthalate/cellulose acetate butyrate blend fiber non-woven fabric;

the graphene modified by diethenetriamine was dispersed into a mixed solvent of ethanol and acetone which were in a volume ratio of 20%-80% to obtain a graphene dispersion solution with a concentration of 0.5 mg/mL;

the carboxyl terminated polyethylene terephthalate/cellulose acetate butyrate blend fiber non-woven fabric was impregnated into the graphene dispersion solution, wherein graphene was adsorbed on the carboxyl terminated hyperbranched polyester fiber while dissolving and removing cellulose acetate butyrate to obtain the carboxyl terminated polyethylene terephthalate nanofiber non-woven fabric loaded with graphene; and

S3, preparation of composite protective material

The support layer, the hydroxyl terminated polyethylene terephthalate fiber nanofiber non-woven fabric loaded with graphene, the carboxyl terminated polyethylene terephthalate fiber nanofiber non-woven fabric loaded with graphene and the skin friendly layer were successively laminated, and then subjected to hot rolling at 130° C. and 2 MPa to obtain a composite protective material for epidemic prevention of COVID-19.

### Comparative Example 2

A composite protective material for epidemic prevention of COVID-19 provided in comparative example 2 comprised a support layer, a nanofiber antibacterial layer and a skin friendly layer which are successively arranged from outside to inside, wherein the nanofiber antibacterial layer comprised a layer of hydroxyl terminated polyethylene terephthalate nanofiber non-woven fabric and a layer of carboxyl terminated polyethylene terephthalate nanofiber non-woven fabric. The preparation method differs from that in comparative example that in the step of S1, the graphene modified by hexamethylene diisocyanate is not added in the mixed solvent of ethanol and acetone; in the step of S2, the graphene modified by diethylenetriamine is not added in the mixed solvent of ethanol and acetone. Others are basically the same as those in example 1, and are not described in detail.

### Comparative Example 3

A composite protective material for epidemic prevention of COVID-19 provided in comparative example 2 differs from that in example 1 in that the nanofiber antibacterial layer comprises a layer of hydroxyl terminated hyperbranched polyester nanofiber non-woven fabric and a layer of carboxyl terminated hyperbranched polyester nanofiber non-woven fabric. Others are substantially the same as those in example 1, and are not described in detail.

TABLE 1
Performance test results of example 1 and comparative examples 1~3

| | | After | | After | | Air |
|---|---|---|---|---|---|---|
| | Staphylococcus | washing 20 | Klebsiella | washing 20 | Breaking | permeability |
| Samples | aureus % | times/%/ | pneumoniae % | times/%/ | strength/N | mm/s |
| Example 1 | 99.8 | 95.3 | 99.6 | 94.6 | 805.7 | 712.43 ± 21.23 |
| Comparative | 73.5 | 60.1 | 72.2 | 60.7 | 745.6 | 726.87 ± 22.25 |
| example 1 | | | | | | |
| Comparative | 0 | 0 | 0 | 0 | 721.3 | 756.22 ± 20.12 |
| example 2 | | | | | | |
| Comparative | 0 | 0 | 0 | 0 | 789.4 | 760.47 ± 21.27 |
| example 3 | | | | | | |

It can be seen from comparative example 2 and comparative example 3 in Table 1 that when the nanofiber antibacterial layer is not loaded with graphene, the protective material has no antibacterial property; when the nanofiber antibacterial layer is a layer of hydroxyl terminated hyperbranched polyester nanofiber non-woven fabric and a layer of carboxyl terminated hyperbranched polyester nanofiber non-woven fabric which are prepared by the disclosure, compared with ordinary polyester, the protective material has significantly improved breaking strength and slightly increased air permeability, which may because: (1) the hydroxyl terminated hyperbranched polyester with a high branching degree and having a softening point of 100° C. in the hydroxyl terminated hyperbranched polyester nanofiber non-woven fabric undergoes melt cohesion, which increases the cohesive strength between fibers in the hydroxyl terminated hyperbranched polyester nanofiber non-woven fabric; (2) the carboxyl terminated hyperbranched polyester with a high branching degree and having a softening point at 100° C. in the carboxyl terminated hyperbranched polyester nanofiber non-woven fabric undergoes melt cohesion, which increases the cohesive strength of the carboxyl terminated hyperbranched polyester nanofiber non-woven fabric; (3) the hydroxyl on the surface of the hydroxyl terminated hyperbranched polyester nanofiber non-woven fabric and carboxyl on the surface of the carboxyl terminated hyperbranched polyester nanofiber non-woven fabric are condensed and crosslinked to form the penetrating network, thereby improving the cohesive strength between the hydroxyl terminated hyperbranched polyester nanofiber non-woven fabric and the carboxyl terminated hyperbranched polyester nanofiber non-woven fabric.

It can be seen from comparative example 1 and example 1 that when the nanofiber antibacterial layer is a layer of hydroxyl terminated hyperbranched polyester nanofiber non-woven fabric loaded with graphene modified by hexamethylene diisocyanate and a layer of carboxyl terminated hyperbranched polyester nanofiber non-woven fabric loaded with graphene modified by diethylenetriamine, compared with ordinary polyester loaded with graphene, the composite protective material of the disclosure has significantly improved antibacterial property and bacteria-resistant durability and breaking strength, and reduced but sill high air permeability, indicating that the crosslinked penetrating network is formed through multiple chemical bonding between fibers, between layers, between graphene and fibers and between graphene and graphene, thereby greatly improving the loading capacity, loading firmness and mechanical strength of graphene and causing little influence on air permeability.

### Examples 2˜3 and Comparative Examples 4˜5

The composite protective materials for epidemic prevention of COVID-19 provided by examples 2˜3 and comparative examples 4˜5 differ from that in example 1 that in the step of S1, a mass ratio of the hydroxyl terminated hyperbranched polyester masterbatch with a high branching degree and having a soften pointing of 100° C. and the hydroxyl terminated hyperbranched polyester masterbatch with a low branching degree and having a soften pointing of 200° C., m₁:m₂, is shown in Table 2. Others are substantially the same as those in example 1, which are not described in detail.

TABLE 2
Test results of examples 2~3 and comparative examples 4~5

| | | | After | | After | | Air |
|---|---|---|---|---|---|---|---|
| | | Staphylococcus | washing 20 | Klebsiella | washing 20 | Breaking | permeability |
| Samples | m₁:m₂ | aureus % | times/%/ | pneumoniae % | times/%/ | strength/N | mm/s |
| Example 2 | 5%:95% | 98.9 | 94.1 | 98.6 | 93.5 | 753.2 | 723.45 ± 21.47 |
| Comparative | 20%:80% | 99.9 | 95.8 | 99.8 | 95.9 | 767.8 | 701.21 ± 20.38 |
| example 3 | | | | | | | |
| Comparative | 0%:100% | 96.4 | 90.2 | 96.1 | 90.5 | 736.7 | 736.45 ± 20.18 |
| example 4 | | | | | | | |
| Comparative | 25%:75% | 99.8 | 95.6 | 99.8 | 95.5 | 745.2 | 689.33 ± 21.34 |
| example 5 | | | | | | | |

It can be seen from Table 2 that as the mass ratio of the hydroxyl terminated hyperbranched polyester masterbatch with a high branching degree and having a soften pointing of 100° C. to the hydroxyl terminated hyperbranched polyester masterbatch with a low branching degree and having a soften pointing of 200° C. is increased, the antibacterial rate and post-washing antibacterial rate of the protective material are both gradually increased, but the breaking strength and air permeability are both increased and then reduced. This is because the content of the terminal hydroxyl in the polyester nanofiber non-woven fabric is gradually increased with the increased content of the hydroxyl terminated hyperbranched polyester masterbatch with a high branching degree and having a soften pointing of 100° C., the degree of multiple chemical bonding between fibers, between layers, between graphene and fibers and between graphenes, and the loading capacity of graphene is gradually increased, so that antibacterial property and breaking strength are increased, and air permeability is reduced. When the content of the hydroxyl terminated hyperbranched polyester masterbatch with a high branching degree and having a softening point of 100° C. is too high, the spinnability becomes poor, leading to reduced breaking strength. Meanwhile, the content of graphene is increased, leading to reduced air permeability and little change in antibacterial property.

### Examples 4˜5 and Comparative Examples 6˜7

The composite protective materials for epidemic prevention of COVID-19 provided by examples 4˜5 and comparative examples 6˜7 differ from the composite protective material in example 1 that in the step of S2, the mass ratio of the carboxyl terminated hyperbranched polyester masterbatch with a high branching degree and having a softening point of 100° C. to the carboxyl terminated hyperbranched polyester masterbatch with a high branching degree and having a softening point of 200° C., m₃:m₄, is shown in Table 3. Others are substantially the same as those in example 1, which are not described in detail.

TABLE 3
Test results of examples 4~5 and comparative examples 6~7

| | | | After | | After | | Air |
|---|---|---|---|---|---|---|---|
| | | Staphylococcus | washing 20 | Klebsiella | washing 20 | Breaking | permeability |
| Samples | m₃:m₄ | aureus % | times/%/ | pneumoniae % | times/%/ | strength/N | mm/s |
| Example 4 | 5%:95% | 98.9 | 94.2 | 98.7 | 93.7 | 754.7 | 725.45 ± 21.39 |
| Comparative | 20%:80% | 99.9 | 95.6 | 99.8 | 95.8 | 765.8 | 703.23 ± 20.30 |
| example 5 | | | | | | | |
| Comparative | 0%:100% | 96.7 | 90.4 | 96.0 | 90.3 | 734.7 | 734.49 ± 20.22 |
| example 6 | | | | | | | |
| Comparative | 25%:75% | 99.7 | 95.2 | 99.8 | 95.3 | 744.3 | 688.42 ± 21.40 |
| example 7 | | | | | | | |

It can be seen from Table 3 that as the mass ratio of the carboxyl terminated hyperbranched polyester masterbatch with a high branching degree and having a soften pointing of 100° C. to the carboxyl terminated hyperbranched polyester masterbatch with a low branching degree and having a soften pointing of 200° C. is increased, the antibacterial rate and post-washing antibacterial rate of the protective material are both gradually increased, but the breaking strength and air permeability are both increased and then reduced. An influencing mechanism is substantially the same as those in examples 2˜3 and comparative examples 4˜5, which is not described in detail.

The above descriptions are only preferred embodiments of the disclosure, but the protective scope of the disclosure is not limited thereto. Equivalent replacements or changes made by any technicians familiar with the technical field according to the technical solution and concept of the disclosure within the technical scope disclosed in the disclosure are all included within the protective scope of the disclosure.

What is claimed is:

1. A composite protective material for epidemic prevention of corona virus disease 2019 (COVID-19), comprising: a support layer, a nanofiber antibacterial layer and a skin friendly layer which are successively arranged from outside to inside, wherein the nanofiber antibacterial layer comprises at least one layer of hydroxyl terminated hyperbranched polyester nanofiber non-woven fabric loaded with graphene and at least one layer of carboxyl terminated hyperbranched polyester nanofiber non-woven fabric loaded with graphene, and the hydroxyl terminated hyperbranched polyester nanofiber non-woven fabric and the carboxyl terminated hyperbranched polyester nanofiber non-woven fabric are adjacently arranged and condensed and crosslinked through terminal hydroxyl and terminal carboxyl to form a penetrating network.

2. The composite protective material for epidemic prevention of corona virus disease 2019 (COVID-19) according to claim 1, wherein the graphene loaded on the hydroxyl terminated hyperbranched polyester nanofiber non-woven fabric is graphene modified by diisocyanate; the graphene loaded on the carboxyl terminated hyperbranched polyester nanofiber non-woven fabric is graphene modified by polyethylene polyamine; and isocyanate of the diisocyanate and the terminal hydroxyl of the hydroxyl terminated hyperbranched polyester nanofiber or the amino of the polyethylene polyamine form chemical bonding, the amino of polyethylene polyamine and the terminal carboxyl of the carboxyl terminated hyperbranched polyester nanofiber or isocyanate of diisocyanate form chemical bonding.

3. The composite protective material for epidemic prevention of corona virus disease 2019 (COVID-19) according to claim 1, wherein the hydroxyl terminated hyperbranched polyester nanofiber non-woven fabric contains hydroxyl terminated hyperbranched polyester with a high branching degree and having a softening point of 80˜120° C. and hydroxyl terminated hyperbranched polyester with a low branching degree and having a softening point of 180˜220° C.; the carboxyl terminated hyperbranched polyester nanofiber non-woven fabric contains carboxyl terminated hyperbranched polyester masterbatch with a high branching degree and having a softening point of 80˜120° C. and carboxyl terminated hyperbranched polyester with a low branching degree and having a softening point of 180˜220° C.

4. The composite protective material for epidemic prevention of corona virus disease 2019 (COVID-19) according to claim 2, wherein the diisocyanate is any one of hexamethylene diisocyanate, toluene diisocyanate or diphenylmethane diisocyanate; the polyethylene polyamine is any one of ethylenediamine, diethylenetriamine, triethylenetetramine and tetraethylene pentamine.

5. The composite protective material for epidemic prevention of corona virus disease 2019 (COVID-19) according to claim 1, wherein the support layer is spunlaced non-woven fabric, spunbond non-woven fabric or meltblown non-woven fabric, and the material of the skin friendly layer is polyimide fiber, dacron, nylon, cotton or polyester cotton.

6. A method for preparing the composite protective material for epidemic prevention of corona virus disease 2019 (COVID-19) according to any one of claim 1, comprising the following steps:
S1, preparation of hydroxyl terminated hyperbranched polyester nanofiber non-woven fabric
hydroxyl terminated hyperbranched polyester masterbatch and cellulose acetate butyrate which are in a mass ratio of 1:(4˜9) are subjected to melt extrusion via a double-screw extruder, drafted and paved into a mesh, so as to obtain a hydroxyl terminated hyperbranched polyester/cellulose acetate butyrate blend fiber non-woven fabric; the hydroxyl terminated hyperbranched polyester masterbatch contains hydroxyl terminated hyperbranched polyester masterbatch with a high branching degree and having a softening point of 80˜120° C. and hydroxyl terminated hyperbranched polyester masterbatch with a low branching degree and having a softening point of 180˜220° C.;
the graphene modified by diiscocyanate is dispersed into a mixed solvent of ethanol and acetone having a volume ratio of 10%:90%˜40%:60% to obtain a graphene dispersion solution having a concentration of 0.2˜1 mg/mL; and
the hydroxyl terminated hyperbranched polyester/cellulose acetate butyrate blend fiber non-woven fabric is impregnated into the graphene dispersion solution so that the graphene is adsorbed on the hydroxyl terminated hyperbranched polyester fiber while dissolving and removing cellulose acetate butyrate, so as to obtain hydroxyl terminated hyperbranched polyester nanofiber non-woven fabric loaded with graphene; and
S2, preparation of carboxyl terminated hyperbranched polyester nanofiber non-woven fabric
carrying out melt extrusion, drafting and paving into a mesh on carboxyl terminated hyperbranched polyester masterbatch and cellulose acetate butyrate which are in a mass ratio of 1:(4˜9) are subjected to melt extrusion via a double-screw extruder, drafted and paved into a mesh via a double-screw extruder to obtain a carboxyl terminated hyperbranched polyester/cellulose acetate butyrate blend fiber non-woven fabric; the carboxyl terminated hyperbranched polyester masterbatch contains carboxyl terminated hyperbranched polyester masterbatch with high branching degree and having a softening point of 80˜120° C. and carboxyl terminated hyperbranched polyester masterbatch with a low branching degree and having a softening point of 180˜220° C.;
the graphene modified by polyethylene polyamine is dispersed into a mixed solvent of ethanol and acetone with a volume ratio of 10%:90%˜40%:60% to obtain a graphene dispersion solution with a concentration of 0.2˜1 mg/mL;
the carboxyl terminated hyperbranched polyester/cellulose acetate butyrate blend fiber non-woven fabric is impregnated into the graphene dispersion solution, graphene is adsorbed on the carboxyl terminated hyperbranched polyester fiber while dissolving and removing cellulose acetate butyrate to obtain the carboxyl terminated hyperbranched polyester nanofiber non-woven fabric loaded with graphene; and
S3, Preparation of composite protective material
the support layer, the hydroxyl terminated hyperbranched polyester fiber nanofiber non-woven fabric loaded with graphene, the carboxyl terminated hyperbranched polyester fiber nanofiber non-woven fabric loaded with graphene and a skin friendly layer are successively laminated, and then hot rolling is carried out at 120˜150° C. and 1˜5 MPa to obtain a composite protective material for epidemic prevention of COVID-19.

7. The method for preparing the composite protective material for epidemic prevention of corona virus disease 2019 (COVID-19) according to claim 6, wherein in the step of S1, a molar ratio of hydroxyl terminated hyperbranched polyester masterbatch with a high branching degree and having a softening point of 80˜120° C. to hydroxyl terminated hyperbranched polyester with a low branching degree and having a softening point of 180˜220° C. is 5%:95%˜20%:80%; in the step of S2, a molar ratio of hydroxyl terminated hyperbranched polyester masterbatch with a high branching degree and having a softening point of 80˜120° C. to hydroxyl terminated hyperbranched polyester mastherbatch with a low branching degree and having a softening point of 180˜220° C. is 5%:95%˜20%:80%.

8. The method for preparing the composite protective material for epidemic prevention of corona virus disease 2019 (COVID-19) according to claim 6, wherein in the step of S2, the carboxyl terminated hyperbranched polyester masterbatch with a high branching degree and having a softening point of 80˜120° C. is obtained by terminal group modification of the hydroxyl terminated hyperbranched polyester masterbatch with a high branching degree and having a softening point of 80˜120° C. with succinic anhydride; the carboxyl terminated hyperbranched polyester masterbatch with a low branching degree and having a softening point of 180˜220° C. is obtained by terminal group modification of the hydroxyl terminated hyperbranched polyester masterbatch with a low branching degree and having a softening point of 180˜220° C. with succinic anhydride.

9. The method for preparing the composite protective material for epidemic prevention of corona virus disease 2019 (COVID-19) according to claim 6, wherein in the step of S1, the hydroxyl terminated hyperbranched polyester masterbatch is prepared by the following steps:
S101, hydroxyl terminated hyperbranched polyester oligomer: trimethylolpropane and dimethylolpropionic acid which are in a molar ratio of 1:(3˜9) is added into a reaction vessel, and then heated to 110˜120° C. for 2˜4 h under the protection of nitrogen to obtain the hydroxyl terminated hyperbranched polyester oligomer;
S102, carboxyl terminated polyester oligomer: dicarboxylic acid and diol which are in a molar ratio of (1.05˜1.3):1 into a reaction vessel, heated to 250˜260° C. under the protection of nitrogen, and react for 2˜4 h to obtain the carboxyl terminated polyester oligomer;
S103, carboxyl terminated polyester oligomer: dicarboxylic acid and diol which are in a molar ratio of (1.5˜1.8):1 are added into a reaction vessel, heated to 250˜260° C. under the protection of nitrogen, and react for 2˜4 h to obtain the carboxyl terminated polyester oligomer;
S104, hydroxyl terminated hyperbranched polyester masterbatch with a low branching degree and having a softening point of 180˜220° C.: the hydroxyl terminated hyperbranched polyester oligomer obtained in step S101 is added into the carboxyl terminated polyester oligomer obtained in step S102, subjected to polycondensation for 1˜3 h at 275˜285° C. and 200˜300 kPa, vacuumized for 2˜4 h, cooled and cut to obtain the hydroxyl terminated hyperbranched polyester masterbatch with a low branching degree and having a softening point of 180˜220° C.; and
S105, hydroxyl terminated hyperbranched polyester masterbatch with a high branching degree and having a softening point of 80˜120° C.: the hydroxyl terminated hyperbranched polyester oligomer obtained in step S101 is added into the carboxyl terminated hyperbranched polyester oligomer obtained in step S103 at 275˜285° C. and 200˜300 kPa, subjected to condensation reaction for 1˜3 h, then vacuumized for 2˜4 h, cooled and cut to obtain the hydroxyl terminated hyperbranched polyester masterbatch with a high branching degree and having a softening point of 80˜120° C.

10. The method for preparing the composite protective material for epidemic prevention of corona virus disease 2019 (COVID-19) according to claim 9, wherein in the step of S104, a mass ratio of the hydroxyl terminated hyperbranched polyester oligomer to the carboxyl terminated hyperbranched polyester oligomer is 1:(4˜6); in the step of S105, a mass ratio of the hydroxyl terminated hyperbranched polyester oligomer to the carboxyl terminated hyperbranched polyester oligomer is 1:(0.5˜1.5).
